(19) United States
(12) Patent Application Publication
(10) Pub. No.: US 2017/0011359 A1
(43) Pub. Date: Jan. 12, 2017

(54) DEVICE MAINTENANCE SERVER AND DEVICE MAINTENANCE SYSTEM

(71) Applicant: MITSUBISHI HITACHI POWER SYSTEMS, LTD., Kanagawa (JP)

(72) Inventor: Akihisa ENDO, Tokyo (JP)

(73) Assignee: MITSUBISHI HITACHI POWER SYSTEMS, LTD., kanagawa (JP)

(21) Appl. No.: 15/100,135

(22) PCT Filed: Nov. 28, 2014
(86) PCT No.: PCT/JP2014/081510

§ 371 Date: May 27, 2016

(30) Foreign Application Priority Data
Dec. 3, 2013 (JP) 2013-250199

(51) Int. Cl. G06Q 10/00; G06K 9/62; G06F 3/00; G06Q 10/10

(52) U.S. Cl. CPC G06Q 10/20; G06Q 10/10; G06K 9/6202; G06F 3/005; G06F 3/0482

(57) ABSTRACT

A device maintenance server (20) includes a storage unit (29) that stores manual information on each component configuring a maintenance target device (90) as viewing information, a communication unit (28) that communicates with a mobile terminal, and a control unit (21) that controls transmission of the manual information to the mobile terminal. When a component (an identified component) imaged in a captured image received from the mobile terminal is a specific component (a component for which a plurality of pieces of manual information according to a period of use that is a period after mounting on the maintenance target device are stored), the control unit (21) controls transmission of one piece of manual information according to the period of use of the identified component to the mobile terminal.

### TECHNICAL FIELD

The present invention relates to a device maintenance server and a device maintenance system.

Priority is claimed on Japanese Patent Application No. 2013-250199, filed Dec. 3, 2013, the content of which is incorporated herein by reference.

### BACKGROUND ART

Technology for holding data regarding an instruction manual of components of a device (for example, a switch) in advance and displaying the instruction manual of the components on a mobile terminal when captured images of the components are acquired by the mobile terminal is known (for example, see Patent Literature 1).

### CITATION LIST

### Patent Literature

### [Patent Literature 1]

Japanese Unexamined Patent Application, First Publication No. 2011-18297

### SUMMARY OF INVENTION

### Technical Problem

In the technology of Patent Literature 1, an appropriate instruction manual according to an elapsed time cannot be displayed for a component for which a handling method is changed over time, that is, a component for which the handling method differs according to an elapsed time after start of use.

The present invention provides a technology capable of displaying an appropriate instruction manual according to an elapsed time even when a component is a component for which the handling method is changed over time.

### Solution to Problem

According to a first aspect of the present invention, a device maintenance server is a device maintenance server that transmits viewing information to be viewed in maintenance work to a mobile terminal carried for the maintenance work of a maintenance target device, the device maintenance server including: a storage unit that stores manual information on each component configuring the maintenance target device as the viewing information; a communication unit that communicates with the mobile terminal; and a control unit that controls transmission of the manual information to the mobile terminal according to information received from the mobile terminal via the communication unit, wherein the storage unit stores a plurality of pieces of manual information according to a period of use that is a period after mounting on the maintenance target device for each of at least a part of specific components among the components configuring the maintenance target device, and stores mounting date and time information of the mounting on the maintenance target device for each of the specific components, and wherein the control unit identifies the component captured in a captured image received from the mobile terminal, calculates the period of use of the identified component from the mounting date and time information of the identified component and a photographing date and time of the captured image or a reception date and time of the captured image when the identified component is the specific component, and controls transmission of one piece of manual information according to the period of use among the plurality of pieces of manual information of the identified component.

Further, according to a second aspect of the present invention, in the device maintenance server according to the first aspect, the storage unit stores manual information that does not depend on the period of use for each component that is not the specific component, and the control unit controls transmission of the manual information according to the identified component when the identified component is not the specific component.

Further, according to a third aspect of the present invention, in the device maintenance server according to the first or second aspect, the storage unit may store a comparative image obtained by previously imaging each of the components or feature amount information on a feature amount of the comparative image; and the control unit may identify the component captured in the captured image on the basis of a degree of similarity of a feature amount of the captured image to the feature amount of the comparative image.

Further, according to a fourth aspect of the present invention, in the device maintenance server according to any one of the first to third aspects, the storage unit may store screen information of a menu screen that causes a work menu according to the component to be selected, store a plurality of pieces of manual information according to the work menu for the component that is not the specific component, and store a plurality of pieces of manual information according to the work menu and the period of use for the specific component. The control unit may control transmission of the screen information to the mobile terminal according to the identified component when the identified component is not the specific component. Then, the control unit may control transmission of one piece of manual information to the mobile terminal according to the work menu specified by selection information when receiving the selection information indicating that any work menu is selected from the mobile terminal, and control the transmission of the screen information according to the identified component to the mobile terminal when the identified component is the specific component. Then, the control unit may control the transmission of one piece of manual information according to the work menu specified by selection information and the period of use to the mobile terminal when receiving the selection information indicating that any work menu is selected from the mobile terminal.

Further, according to a fifth aspect of the present invention, in the device maintenance server according to the fourth aspect, the storage unit may store screen information of the layered menu screen, and store the manual information in association with the work menu on a bottom layer. The control unit may control the transmission of the screen information according to the identified component to the mobile terminal when the identified component is not the specific component. Then, the control unit may control the transmission of one piece of manual information according to the work menu to the mobile terminal when receiving selection information indicating that any work menu on the bottom layer is selected from the mobile terminal, and control the transmission of the screen information according to the identified component to the mobile terminal when the identified component is the specific component. Then, the control unit may control the transmission of one piece of manual information according to the work menu and the period of use to the mobile terminal when receiving the selection information indicating that any work menu on the bottom layer is selected from the mobile terminal.

Further, according to a sixth aspect of the present invention, in the device maintenance server according to any one of the first to fifth aspects, the storage unit may store system diagrams regarding the maintenance target device, and the control unit may control transmission of a system diagram of the identified component to the mobile terminal.

Further, according to a seventh aspect of the present invention, in the device maintenance server according to the sixth aspect, the communication unit may receive alarm information in the maintenance target device, and the control unit may generate a system diagram in which an area is highlighted according to the alarm information and control transmission of the system diagram to the mobile terminal.

Further, according to an eighth aspect of the present invention, in the device maintenance server according to any one of the first to seventh aspects, the communication unit may receive order information of the component or work performance information after the maintenance work.

According to a ninth aspect of the present invention, a device maintenance system is a device maintenance system including a device maintenance server that stores viewing information to be viewed in maintenance work of a maintenance target device, and a mobile terminal that communicates with the device maintenance server, wherein the mobile terminal includes: a display unit that displays the viewing information; an operation reception unit that receives an operation of an operator; an imaging unit that images the maintenance target device; and a terminal-side communication unit that communicates with the device maintenance server, wherein the device maintenance server includes: a storage unit that stores manual information on each component configuring the maintenance target device as the viewing information; a server-side communication unit that communicates with the mobile terminal; and a control unit that controls transmission of the manual information to the mobile terminal according to information received from the mobile terminal via the server-side communication unit, wherein the storage unit stores a plurality of pieces of manual information according to a period of use that is a period after mounting on the maintenance target device for each of at least a part of the components configuring the maintenance target device, and stores mounting date and time information of mounting on the maintenance target device for each specific component that is a component for which the plurality of pieces of manual information according to the period of use are stored, wherein the terminal-side communication unit transmits a captured image of the component captured using the imaging unit to the device maintenance server, and wherein the control unit identifies the component captured in the captured image received from the mobile terminal, calculates the period of use of the identified component from the mounting date and time information of the identified component and a photographing date and time of the captured image or a reception date and time of the captured image when the identified component is the specific component, and controls transmission of one piece of manual information according to the period of use among the plurality of pieces of manual information of the identified component.

### Advantageous Effects of Invention

With the device maintenance server and the device maintenance system described above, it is possible to display an appropriate instruction manual according to an elapsed time for a component for which a handling method is changed over time.

### BRIEF DESCRIPTION OF DRAWINGS

FIG. 1 is a configuration diagram showing a device maintenance system according to an embodiment of the present invention.

FIG. 2A shows an example of a functional block diagram of a mobile terminal.

FIG. 2B shows an example of a functional block diagram of a server.

FIG. 2C shows an example of a functional block diagram of a management apparatus.

FIG. 3A shows an example of information that is stored in the server.

FIG. 3B shows an example of information that is stored in the server.

FIG. 4A shows an example of information that is stored in the server.

FIG. 4B shows an example of information that is stored in the server.

FIG. 4C shows an example of information that is stored in the server.

FIG. 5A shows an example of information that is stored in the server.

FIG. 5B shows an example of information that is stored in the server.

FIG. 6A shows an example of information that is stored in the server.

FIG. 6B shows an example of information that is stored in the server.

FIG. 7 shows an example of information that is stored in the server.

FIG. 8 shows an example of information that is stored in the server.

FIG. 9A shows an example of information that is displayed on the mobile terminal.

FIG. 9B shows an example of information that is displayed on the mobile terminal.

FIG. 10A shows an example of information that is displayed on the mobile terminal.

FIG. 10B shows an example of information that is displayed on the mobile terminal.

FIG. 11 shows an example of information that is displayed on the mobile terminal.

FIG. 12 is a flowchart showing an example of an operation of the mobile terminal and the server.

FIG. 13 is a flowchart showing an example of an operation of the mobile terminal and the server.

FIG. 14A is a flowchart showing an example of an operation of the mobile terminal and the server.

FIG. 14B is a flowchart showing an example of an operation of the mobile terminal and the server.

### DESCRIPTION OF EMBODIMENTS

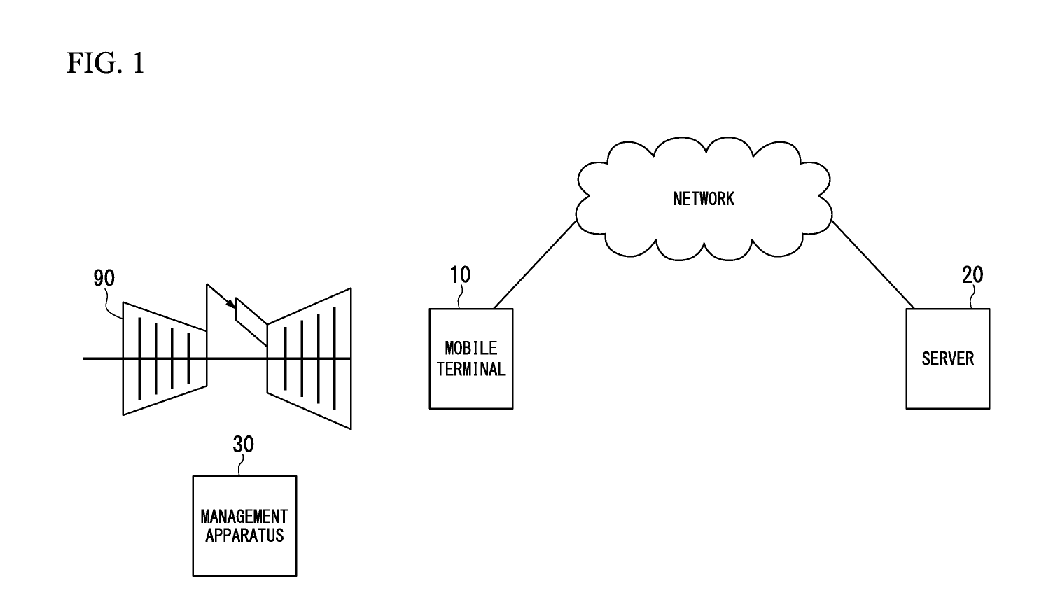

Hereinafter, an embodiment of the present invention will be described with reference to the accompanying drawings. FIG. 1 is a configuration diagram showing a device maintenance system according to an embodiment of the present invention (hereinafter simply referred to also as a device maintenance system). The device maintenance system includes a mobile terminal 10 and a server 20. In this embodiment, the device maintenance system includes a management apparatus 30 in addition to the mobile terminal 10 and the server 20. The mobile terminal 10 and the server 20 can communicate with each other over a network (for example, the Internet). Further, the mobile terminal 10 can acquire information that is stored in the management apparatus 30 over a network (for example, a wireless LAN) or via a storage medium.

The management apparatus 30 manages (for example, controls or diagnoses) a maintenance target device (a device which is a maintenance target) 90, and stores various types of information on the maintenance target device 90, such as alarm information (an alarm) in the maintenance target device 90. That is, the management apparatus 30 stores an alarm log of the maintenance target device 90. The alarm information includes at least information (for example, a component ID) for identifying which component of the maintenance target device the alarm is for. A specific example of the management apparatus 30 is a personal computer.

In the maintenance target device 90, at least a part of a plurality of constituent components is components for which a handling method is changed over time (components for which the handling method is different according to an elapsed time since start of use). That is, any device including a component for which a handling method is changed over time corresponds to the maintenance target device 90. A specific example of the maintenance target device 90 is a gas turbine.

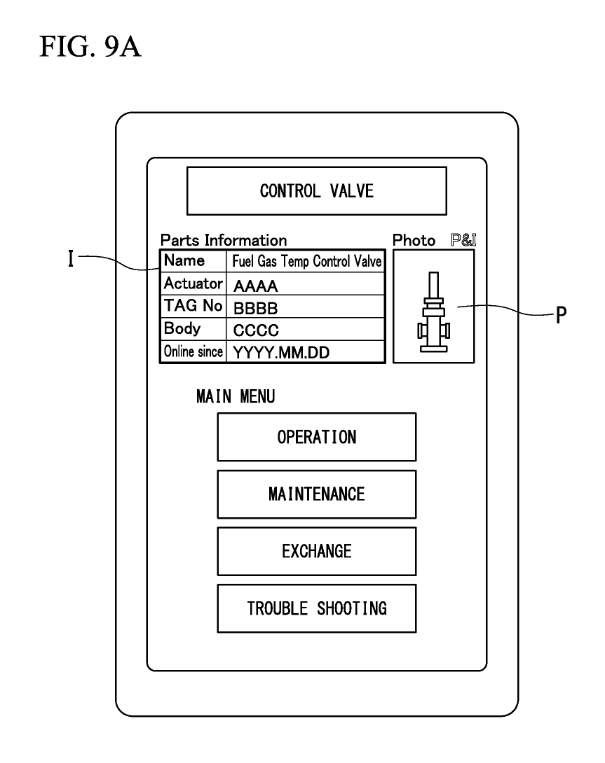

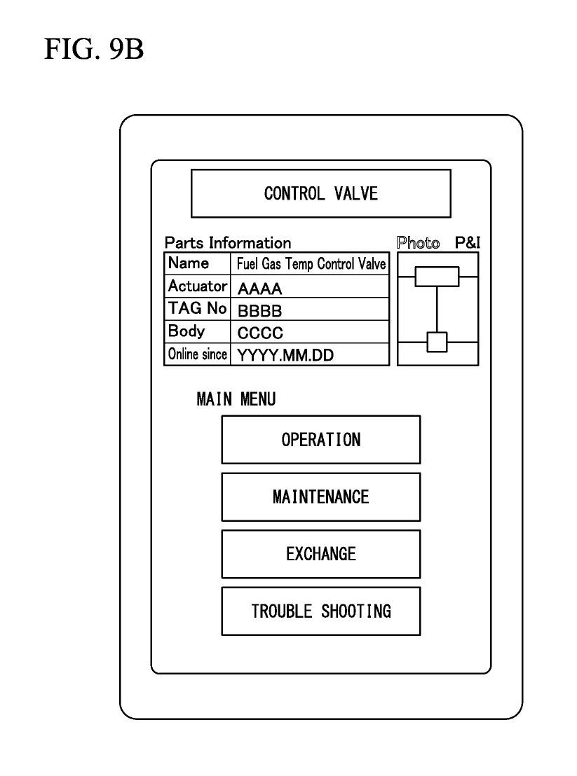

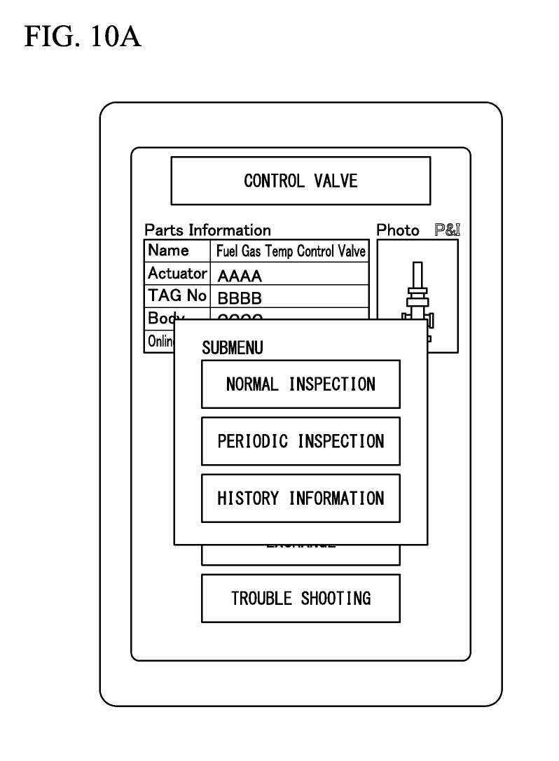

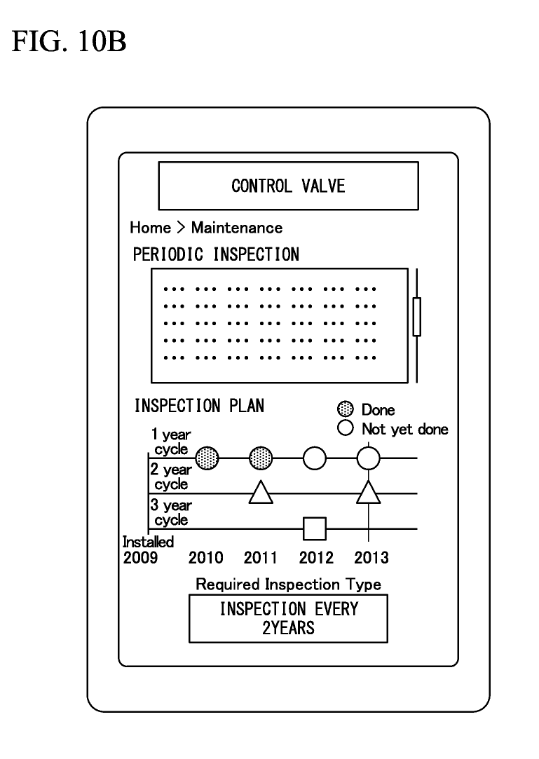

The mobile terminal 10 is carried for maintenance work of the maintenance target device 90, and displays viewing information which is viewed in the maintenance work. A specific example of the mobile terminal 10 is, for example, a tablet terminal or a smartphone having a touch display as shown in FIGS. 9A, 9B, 10A 10B and 11.

The viewing information is information that is viewed as necessary in the maintenance work by maintenance personnel (a maintenance technician) of the maintenance target device 90. For example, information on an operation manual (hereinafter simply also referred to as a manual) and a system diagram (a P&I diagram) is included in the viewing information.

The server 20 stores the above-described viewing information and transmits the viewing information to the mobile terminal 10. For example, the server 20 transmits information on a manual (manual information) of a certain component constituting a part of the maintenance target device 90 to the mobile terminal 10.

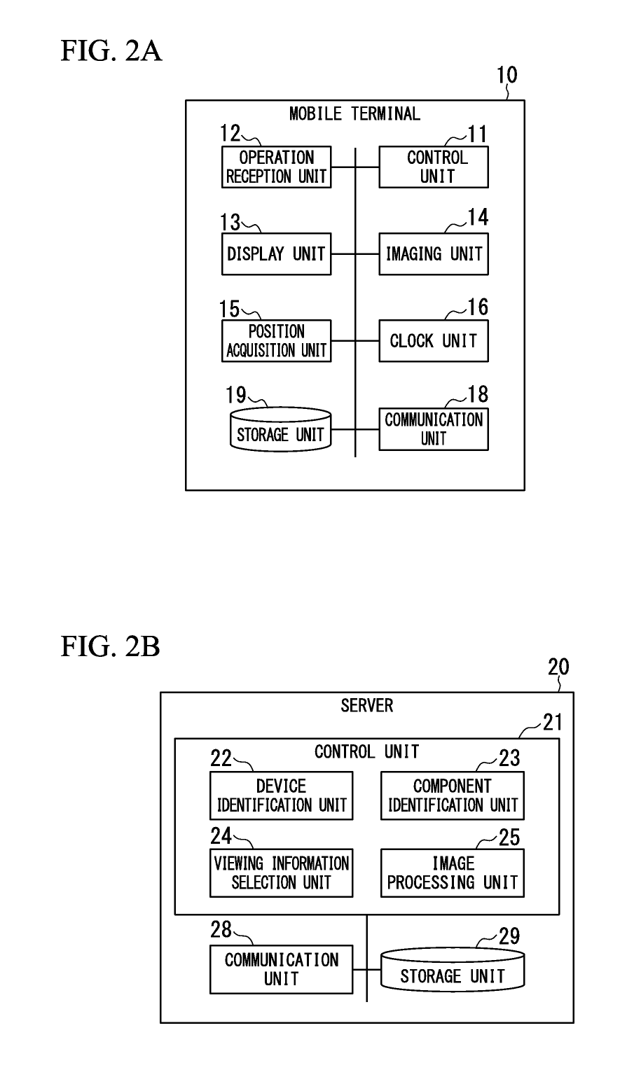

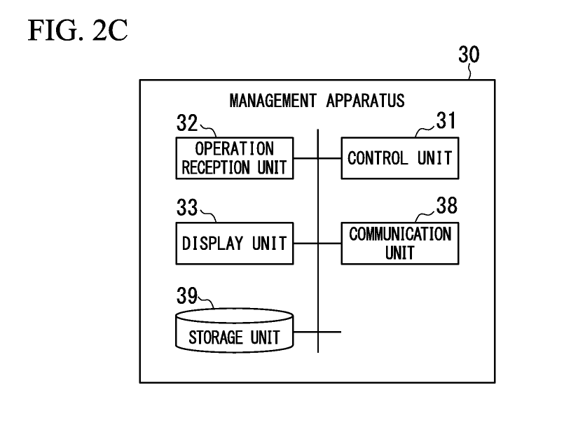

FIG. 2A shows an example of a functional block diagram of the mobile terminal 10. FIG. 2B shows an example of a functional block diagram of the server 20. FIG. 2C shows an example of a functional block diagram of the management apparatus 30. The mobile terminal 10 includes a control unit 11, an operation reception unit 12, a display unit 13, an imaging unit 14, a position acquisition unit 15, a clock unit 16, a communication unit 18, and a storage unit 19, as shown in FIG. 2A. In the mobile terminal 10 having a touch display, the touch display corresponds to the operation reception unit 12 and the display unit 13.

The control unit 11 controls the entire mobile terminal 10. The operation reception unit 12 receives an operation (for example, a touch) of an operator (a maintenance person) as input information. The display unit 13 displays various types of information such as a menu screen and the viewing information. The imaging unit 14 images a subject (the maintenance target device 90 (a component of the maintenance target device 90)) according to an operation of the operator. The imaging unit 14 is, for example, a camera unit including a lens, an imaging element, and the like. An image (a captured image, including a through image) obtained by the imaging unit 14 is supplied to the display unit 13 or the communication unit 18, for example, under control of the control unit 11.

The position acquisition unit 15 acquires, for example, a current position using a GPS system. The clock unit 16 outputs a current time. The communication unit 18 communicates with the outside (for example, the server 20 or the management apparatus 30). For example, the communication unit 18 transmits the captured image of the component from the imaging unit 14 to the server 20. Further, the communication unit 18 may transmit information (for example, alarm information) acquired from the management apparatus 30 to the server 20. Further, the communication unit 18 may transmit time information (the current time) obtained from the clock unit 16 to the server 20. Further, the communication unit 18 transmits component order information or work performance information after maintenance work to a predetermined server (which may be the server 20 or may be a server different from the server 20). The storage unit 19 stores various programs and various types of information such as information acquired via the communication unit 18. The storage unit 19 may store a user ID.

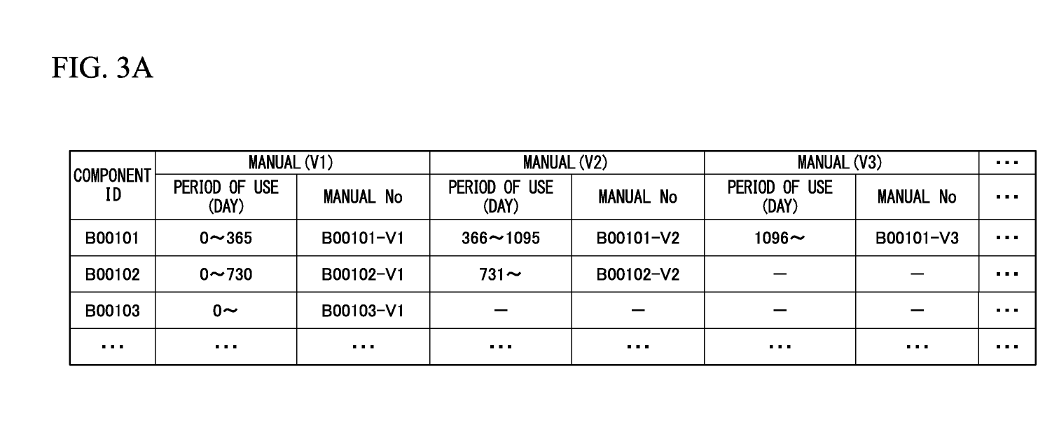

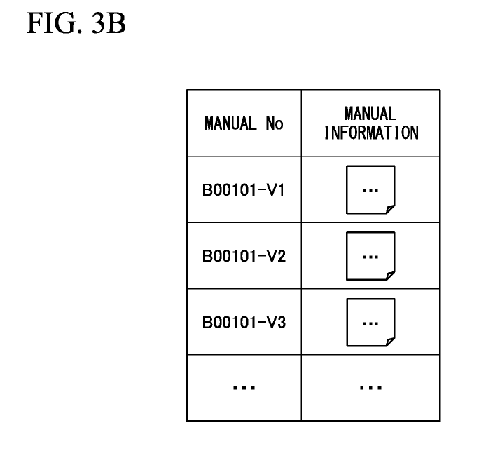

The server 20 includes a control unit 21, a communication unit 28, and a storage unit 29, as shown in FIG. 2B. The control unit 21 controls the entire server 20. For example, the control unit 21 controls transmission of the manual information to the mobile terminal 10 according to the information received from the mobile terminal 10 via the communication unit 28. The storage unit 29 stores various programs, and various types of information such as information to be transmitted to the mobile terminal 10 via the communication unit 28. For example, the storage unit 29 stores manual information on each of the components constituting the maintenance target device 90 as the viewing information. The communication unit 28 communicates with the outside (for example, the mobile terminal 10 or another server). The control unit 21 includes a device identification unit 22, a component identification unit 23, a viewing information selection unit 24, and an image processing unit 25, as shown in FIG. 2B. Hereinafter, a detailed description will be given with reference to FIGS. 3A and 3B to FIG. 8. FIGS. 3A and 3B to FIG. 8 show examples of information that is stored in the server 20.

The storage unit 29 stores a plurality of pieces of manual information according to a period after mounting on the maintenance target device 90 (hereinafter also referred to as a period of use) for each of at least a part of the components constituting the maintenance target device 90.

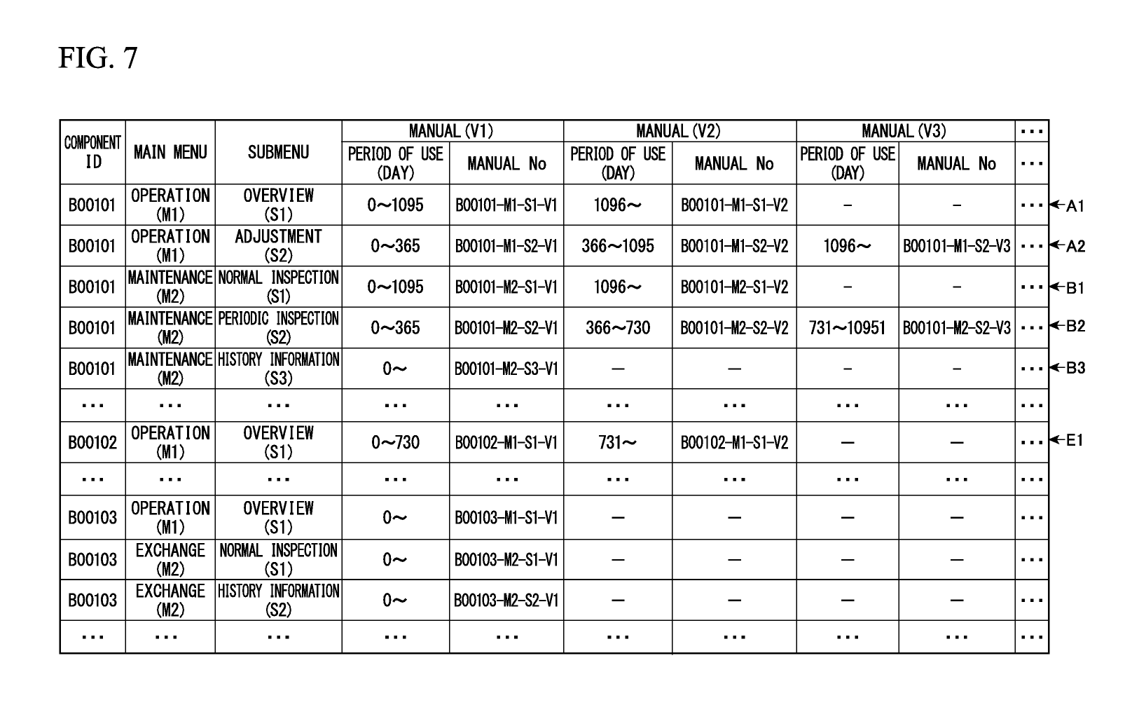

For example, the storage unit 29 stores sets of a period of use and a manual number in association with component IDs, as shown in FIG. 3A. The component ID is identification information for identifying the component. The manual number is identification information for identifying the manual information (data which is an entity of the manual), and the storage unit 29 also stores the manual information in association with the manual number (similarly to the case of FIG. 7), as shown in FIG. 3B. For convenience of description, for each component ID, a first set of a period of use and a manual number is a manual V1, a second set of a period of use and a manual number is a manual V2, and a third set of a period of use and a manual number is a manual V3. The symbol “ . . . ” in FIG. 3A (within the table) indicates omission of description, and the symbol “-” indicates no storage (no setting). The same applies to the other figures.

In the example shown in FIG. 3A, the storage unit 29 stores a set of a period of use “0 to 365” and a manual number “B00101-V1”, a set of a period of use “366 to 1095” and a manual number “B00101-V2”, and a set of a period of use “1096 or more” and a manual number “B00101-V3” for a component ID “B00101”. Further, the storage unit 29 stores a set of a period of use “0 to 730” and a manual number “B00102-V1” and a set of a period of use “731 or more” and a manual number “B00102-V2” for a component ID “B00102”. Further, the storage unit 29 stores a set of a period of use “0 or more” and a manual number “B00103-V1” for a component ID “B00103”.

That is, in the example shown in FIGS. 3A and 3B, the storage unit 29 stores, for a component with the component ID “B00101”, manual information identified by the manual number “B00101-V1” as information to be viewed when the period of use is 0 day (before 1 day elapses) to 365 days, stores manual information identified by the manual number “B00101-V2” as information to be viewed when the period of use is 365 days to 1095 days, and stores manual information identified by the manual number “B00101-V3” as information to be viewed when the period of use is 1096 days or more. Further, the storage unit 29 stores, for a component with the component ID “B00102”, manual information identified by the manual number “B00102-V1” as information to be viewed when the period of use is 0 day (before 1 day elapses) to 730 days, and stores manual information identified by the manual number “B00102-V2” as information to be viewed when the period of use is 731 days or more. Further, the storage unit 29 stores manual information identified by the manual number “B00103-V1” as information to be viewed when the period of use is 0 day or more (that is, regardless of the period of use) for a component with the component ID “B00103”.

That is, in the example shown in FIGS. 3A and 3B, the storage unit 29 stores a plurality of pieces of manual information according to the period of use for the component with the component ID “B00101” and the component with the component ID “B00102” among the component with the component ID “B00101”, the component with the component ID “B00102”, and the component with the component ID “B00103”. On the other hand, the storage unit 29 stores one piece of manual information for the component with the component ID “B00103”.

Further, the storage unit 29 stores mounting date and time information (a start date of use) of mounting on the maintenance target device 90 for each of at least a part of the components constituting the maintenance target device 90. Specifically, the storage unit 29 stores the mounting date and time information of mounting on the maintenance target device 90 for each component for which a plurality of pieces of manual information according to the period of use are stored (hereinafter, referred to as a specific component).

Specific components are, of course, different for each maintenance target device 90, but the specific components are a fuel control valve, a fuel control valve servo actuator, a main oil pump, and the like when the maintenance target device 90 is a gas turbine. For the fuel control valve, operation confirmation is performed every year, and major inspection is performed every two years. For the fuel control valve servo actuator, major inspection is performed every two years. For the main oil pump, major inspection is performed every four years. For example, if a different piece of manual information is referred to every time in every time (every year) of operation confirmation of the fuel control valve, a different piece of manual information may be prepared (stored) for every year of the period of use of the fuel control valve as a plurality of pieces of manual information for operation confirmation of the fuel control valve. Further, if a different piece of manual information is referred to in every second time of operation confirmation of the fuel control valve, a different piece of manual information may be prepared for every two years of the period of use of the fuel control valve as a plurality of pieces of manual information for operation confirmation of the fuel control valve. Further, the length of the period of use in which the same manual information is referred to does not have to be constant, such as manual information for first operation confirmation of the fuel control valve, manual information for second and third operation confirmations, and manual information for fourth to seventh operation confirmations. The same applies to a plurality of pieces of manual information for the major inspection of the fuel control valve, a plurality of pieces of manual information for the major inspection of the fuel control valve servo actuator, and a plurality of pieces of manual information for the major inspection of the main oil pump. Accordingly, when maintenance work (for example, major inspection) of a specific component is performed, manual information for the maintenance work of the specific component according to the period of use of the specific component is specified.

(Storage of Start Date of Use for Each User ID, Device ID, and Component ID)

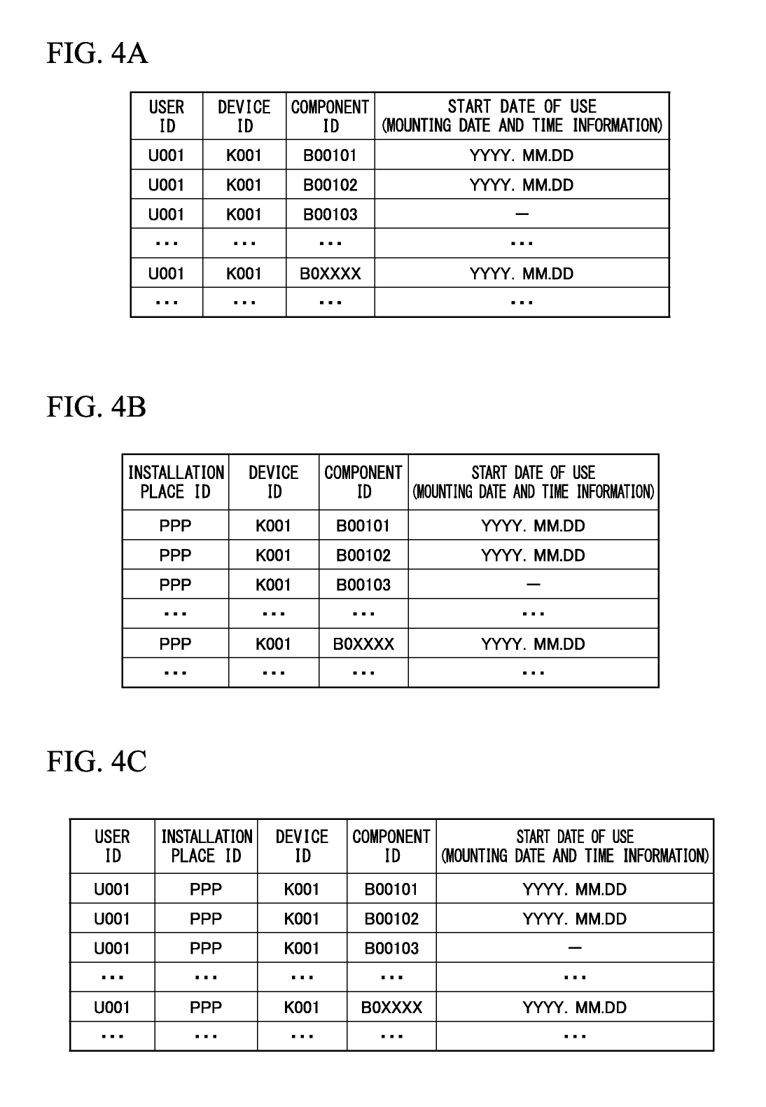

For example, the storage unit 29 stores a start date of use in association with a user ID, a device ID, and a component ID, as shown in FIG. 4A. The device ID is identification information for identifying the device (the maintenance target device). The user ID is identification information for identifying a user who has introduced (installed) the device. By storing the component ID in association with the device ID as shown in FIG. 4A, it is possible to distinguish the same components used in different devices. Further, by storing the component ID in association with the user ID as shown in FIG. 4A, it is possible to distinguish the same components used in the same devices introduced by different users.

If the storage unit 29 stores the start date of use in association with the user ID, the device ID, and the component ID, the storage unit 29 may store the device ID for each user ID. Accordingly, if a different type of maintenance target device 90 is not installed for the user (the same user) identified by the user ID, it is possible to specify the device ID from the user ID.

(Storage of Start Date of Use for Each Installation Place ID, Device ID, and Component ID)

Further, the storage unit 29 may store the start date of use in association with an installation place ID, the device ID, and the component ID, as shown in FIG. 4B. The installation place ID is identification information for identifying an installation place of the device. The installation place ID may be, for example, information based on latitude and longitude or may be address information. As shown in FIG. 4B, by storing the component ID in association with the installation place ID, it is possible to distinguish the same components used in the same devices installed at different places. The same components used in the same devices introduced by the same user in the installation place identified by the installation place ID may be distinguished by information on the user being included in the installation place (for example, a company A, an office B, a building C, and an area D).

When the storage unit 29 stores the start date of use in association with the installation place ID, the device ID, and the component ID, the storage unit 29 may store the device ID for each installation place ID. Accordingly, if another type of maintenance target device 90 is not installed at an installation place (the same installation place) identified by a certain installation place ID, it is possible to identify the device ID of the device from the setting place ID.

(Storage of Start Date of Use for Each User ID, Installation Place ID, Device ID, and Component ID)

Further, the storage unit 29 may store the start date of use in association with the user ID, the installation place ID, the device ID, and the component ID, as shown in FIG. 4C. In a case in which both of the user ID and the installation place ID are stored, the installation place ID indicates a detailed setting place (for example, the office B, the building C, the area D, a right end of a column E). As shown in FIG. 4C, by storing the component ID in association with the user ID and the installation place ID, it is possible to distinguish the same components used in the same devices introduced by the same user.

If the storage unit 29 stores the start date of use in association with the user ID, the installation place ID, the device ID, and the component ID, the storage unit 29 may store the device ID for each user ID and each installation place ID. This makes it possible to specify the device ID from the user ID and the installation place ID.

The control unit 21 (the device identification unit 22) identifies the maintenance target device 90 imaged in the captured image received from the mobile terminal 10. More specifically, the control unit 21 (the device identification unit 22) identifies the maintenance target device 90 imaged in the captured image on the basis of information received from the mobile terminal 10.

For example, if the storage unit 29 stores the start date of use for each user ID, device ID, and component ID and stores the device ID for each user ID as shown in FIG. 4A, the control unit 21 (the device identification unit 22) acquires the user ID from the mobile terminal 10 and identifies the maintenance target device 90 imaged in the captured image based on the acquired user ID. The mobile terminal 10 may transmit the user ID to the server 20 before transmitting the captured image, may transmit the user ID together with the captured image to the server 20, or may transmit the user ID to the server 20 after transmitting the captured image.

Further, if the storage unit 29 stores the start date of use for each installation place ID, device ID, and component ID and stores the device ID for each installation place ID as shown in FIG. 4B, the control unit 21 (the device identification unit 22) acquires the position information from the mobile terminal 10, specifies the installation place ID from the position information, and identifies the maintenance target device 90 imaged in the captured image based on the specified installation place ID. The mobile terminal 10 may transmit the position information to the server 20 before transmitting the captured image, may transmit the position information together with the captured image to the server 20, or may transmit the position information to the server 20 after transmitting the captured image.

Further, if the storage unit 29 stores the start date of use for each user ID, installation place ID, device ID, and component ID and stores the device ID for each user ID and installation place ID as shown in FIG. 4C, the control unit 21 (the device identification unit 22) acquires the user ID and the position information from the mobile terminal 10, specifies the installation place ID from the position information, and identifies the maintenance target device 90 imaged in the captured image based on the acquired user ID and the specified installation place ID.

The control unit 21 (the device identification unit 22) may identify the maintenance target device 90 imaged in the captured image using the captured image itself rather than the user ID or the position information, similarly to the control unit 21 (the component identification unit 23) to be described below.

The control unit 21 (the device identification unit 22) may identify the maintenance target device 90 imaged in the captured image using the captured image itself in addition to the user ID or the position information, similarly to the control unit 21 (the component identification unit 23) to be described below.

The control unit 21 (the component identification unit 23) identifies a component of the maintenance target device 90 imaged in the captured image. More specifically, the control unit 21 (the component identification unit 23) identifies, from the captured image, the component of the maintenance target device 90 imaged in the captured image. For example, the control unit 21 (the component identification unit 23) compares a previously captured comparative image for each component with the captured image to identify the component imaged in the captured image. More specifically, the control unit 21 (the component identification unit 23) identifies the component imaged in the captured image based on a degree of similarity of a feature amount of the captured image to a feature amount of the comparative image.

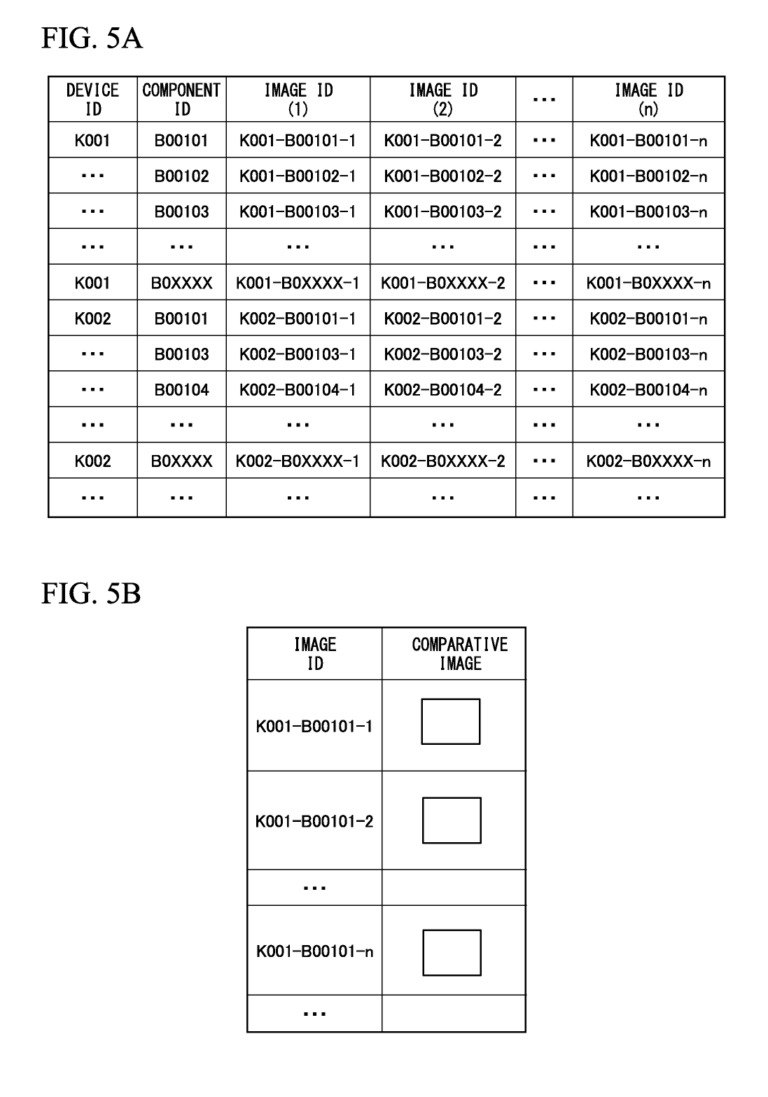

For example, the comparative image is stored in the storage unit 29, as shown in FIGS. 5A and 5B. In the example shown in FIG. 5A, the storage unit 29 stores image IDs (image ID (1) to image ID (n)) of a plurality of comparative images in association with the device ID and the component ID. The image ID is identification information for identifying the comparative image (data that is an entity of the comparative image), and the storage unit 29 also stores the comparative image in association with the image ID, as shown in FIG. 5B. The number of comparative images for each component (“n” of image ID (n)) may be different according to the device ID and the component ID.

A plurality of comparative images associated with a certain device ID and a certain component ID are images captured at different angles. For example, the comparative images with respective image IDs (“K001-B00101-1”, “K001-B00101-2”, . . . , “K001-B00101-n”) stored in association with the component ID “B00101” of a device ID “K001” are captured at different angles. Further, it is preferable for each comparative image to be an image captured in a state in which each component is used (a state in which the component is attached to the device).

As shown in FIGS. 5A and 5B, if the comparative images are stored in the storage unit 29, the control unit 21 (the component identification unit 23) calculates a feature amount of the captured image and a feature amount of the comparative image, compares the feature amounts to determine whether the feature amounts match (pattern matching), and identifies the component based on the degree of matching (the degree of similarity).

For example, the control unit 21 (the component identification unit 23) determines one comparative image that is most similar to the captured image, and determines that the component with the component ID corresponding to the comparative image is the component imaged in the captured image. For example, in the examples of FIGS. 5A and 5B, when the control unit 21 (the component identification unit 23) determines that the comparative image with the image ID “K001-B00101-2” is most similar to the captured image, the control unit 21 (the component identification unit 23) determines that the component with the component ID “B00101” corresponding to the image ID “K001-B00101-2” is the component imaged in the captured image. When the control unit 21 (the component identification unit 23) determines that the comparative image with the image ID “K002-B00104-1” is most similar to the captured image, the control unit 21 (the component identification unit 23) determines that the component with the component ID “B00104” corresponding to the image ID “K002-B00104-1” is the component imaged in the captured image.

As another example, the control unit 21 (the component identification unit 23) may determine that a component with a component ID of which the number of comparative images similar to the captured image to a degree equal to or higher than a predetermined threshold is the largest is the component imaged in the captured image. In the case of this method, it is preferable for the numbers (a value of “n” of image ID (n)) of comparative images of respective components in the same device to be the same or substantially the same.

The storage unit 29 may store feature amount information on the feature amount of the comparative image instead of the comparative image. That is, the storage unit 29 may store feature amount information IDs (feature amount information ID (1) to feature amount information ID (n)) for identifying the feature amount information of a plurality of comparative images in association with the device ID and the component ID, and store the feature amount information of the comparative image in association with the feature amount information ID. Accordingly, the control unit 21 (the component identification unit 23) can save time by not calculating the feature amount of the comparative image.

The control unit 21 (the viewing information selection unit 24) having identified the component selects one piece of manual information to be transmitted to the mobile terminal 10 from among the plurality of pieces of manual information stored in the storage unit 29. Specifically, when the component identified (hereinafter also referred to as an identified component) is a specific component (a component for which a plurality of pieces of manual information according to the period of use are stored), the control unit 21 (the viewing information selection unit 24) calculates the period of use of the identified component from mounting date and time information of the identified component and a photographing date and time of the captured image or a reception date and time of the captured image, and selects one piece of manual information according to the period of use from among the plurality of pieces of manual information of the identified component. Further, when the identified component is not a specific component, the control unit 21 (the viewing information selection unit 24) controls transmission of the manual information corresponding to the identified component.

More specifically, for example, the control unit 21 (the viewing information selection unit 24) determines whether the identified component is the specific component, that is, whether a plurality of pieces of manual information are stored in association with the component ID of the identified component. For example, according to the example of FIG. 3A, when the component ID of the identified component is “B00101” or “B00102”, the control unit 21 (the viewing information selection unit 24) determines that the identified component is the specific component. Further, when the component ID of the identified component is “B00103”, the control unit 21 (the viewing information selection unit 24) determines that the identified component is not the specific component.

When the control unit 21 (the viewing information selection unit 24) determines that the identified component is the specific component, the control unit 21 (the viewing information selection unit 24) calculates the period of use of the identified component from the start date of use of the identified component obtained by referring to the information shown in FIGS. 4A, 4B and 4C and the photographing date and time of the captured image (or the reception date and time of the captured image). The control unit 21 (the viewing information selection unit 24) may acquire the photographing date and time from additional information of the captured image or may acquire the photographing date and time from the mobile terminal 10. Subsequently, the control unit 21 (the viewing information selection unit 24) selects one piece of manual information according to the period of use from among the pieces of manual information of the identified component by referring to the information shown in FIGS. 3A and 3B. When the control unit 21 (the viewing information selection unit 24) determines that the identified component is not the specific component, the control unit 21 (the viewing information selection unit 24) selects the manual information of the identified component by referring to the information shown in FIGS. 3A and 3B. In other words, when there are two or more pieces of manual information corresponding to the identified component according to the period of use, the control unit 21 (the viewing information selection unit 24) selects one piece of manual information according to the period of use of the identified component. Further, when there is only one piece of manual information corresponding to the identified component, the control unit 21 (the viewing information selection unit 24) selects the one piece of manual information.

The control unit 21 (the viewing information selection unit 24) controls the transmission of the selected manual information to the mobile terminal 10.

Further, the storage unit 29 may store screen information of a menu screen for selection of a work menu according to a component. For example, the storage unit 29 may store screen information of a layered menu screen.

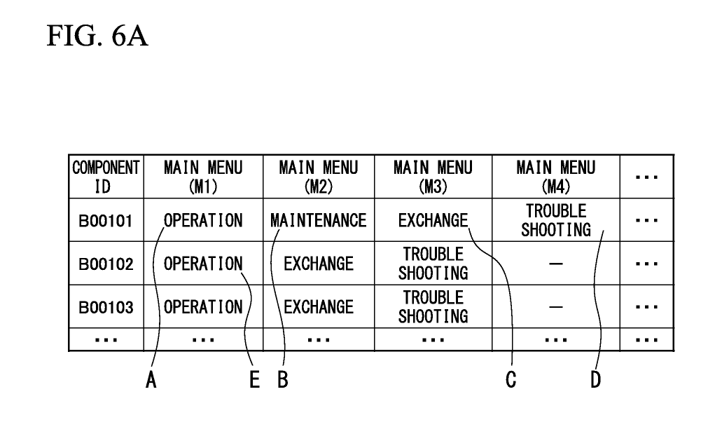

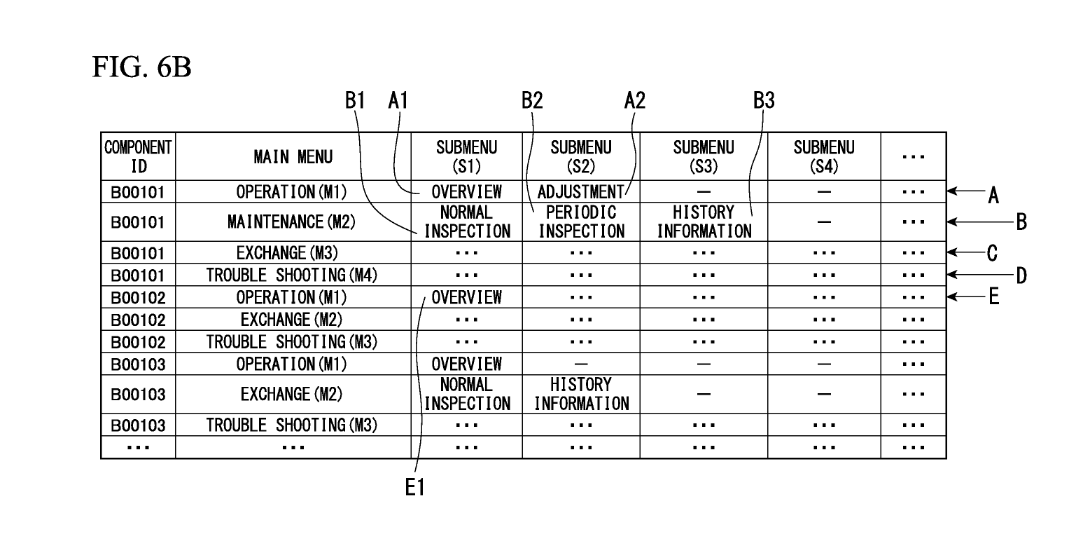

For example, the storage unit 29 may store screen information for a menu screen of two layers including a main menu and a submenu, as shown in FIGS. 6A and 6B. That is, the storage unit 29 may store phrases of a work menu (a main menu) arranged in the main menu screen in association with the component ID as shown in FIG. 6A, and store phrases of a work menu (a submenu) arranged in a submenu screen in association with the component ID and the main menu as shown in FIG. 6B. For convenience of description, for each component ID, a first main menu is a main menu M1, a second main menu is a main menu M2, a third main menu is a main menu M3, and so on. The same applies to the submenus.

In the example shown in FIG. 6A, for example, work menus “Operation (A in FIG. 6A)”, “Maintenance (B in FIG. 6A)”, “Exchange (C in FIG. 6A)”, and “Trouble shooting (D in FIG. 6A)” are set in the main menu screen regarding the component with the component ID “B00101”. Further, work menus “Operation (E in FIG. 6A)”, “Exchange”, and “Trouble shooting” are set in the main menu screen regarding the component with the component ID “B00102”. In the example shown in FIG. 6B, for example, in the submenu screen under the work menu “Operation (A in FIG. 6B)” of the main menu screen regarding the component with the component ID “B00101”, work menus “Overview (A1 in FIG. 6B)” and “Adjustment (A2 in FIG. 6B)” are set. Further, in the submenu screen under the work menu “Maintenance (B in FIG. 6B)” of the main menu screen regarding the component with the component ID “B00101”, work menus “Normal inspection (B1 in FIG. 6B)”, “Periodic inspection (B2 in FIG. 6B)”, and “History information (B3 in FIG. 6B)” are set. Further, in the submenu screen under the work menu “Operation (E in FIG. 6B)” of the main menu screen regarding the component with the component ID “B00102”, a work menu such as “Overview (E1 in FIG. 6B)” is set.

When the storage unit 29 stores screen information of a non-layered menu screen, the storage unit 29 may store a plurality of pieces of manual information according to a work menu for a non-specific component, and may store a plurality of pieces of manual information according to the work menu and the period of use for a specific component.

Further, when the storage unit 29 stores the screen information of a layered menu screen, the storage unit 29 may store a plurality of pieces of manual information according to a work menu on a bottom layer for a non-specific component, and may store a plurality of pieces of manual information according to the work menu on the bottom layer and the period of use for a specific component.

For example, when the storage unit 29 stores the screen information of the menu screen of two layers including a main menu and a submenu as shown in FIGS. 6A and 6B, the storage unit 29 stores sets of a period of use and a manual number in association with the component ID, the main menu, and the submenu, as shown in FIG. 7.

That is, in the example shown in FIG. 7, the storage unit 29 stores a plurality of pieces of manual information according to the submenu on a bottom layer (manual information with “B00103-M1-S1-V1” for the submenu “Overview”, manual information with “B00103-M2-S1-V1” for the submenu “Normal inspection”, and manual information with “B00103-M2-S2-V1” for the submenu “History information”) for a component (for example, the component with the component ID “B00103”) that is not a specific component. Further, the storage unit 29 stores a plurality of pieces of manual information according to a work menu on the bottom layer and the period of use for a specific component (for example, the component with the component ID “B00101” and the component with the component ID “B00102”).

When the storage unit 29 stores the screen information of a non-layered menu screen, and when the identified component is not the specific component, the control unit 21 (the viewing information selection unit 24) controls transmission of the screen information to the mobile terminal 10 according to the identified component. Thereafter, when the control unit 21 (the viewing information selection unit 24) receives selection information indicating that one work menu is selected from the mobile terminal 10, the control unit 21 controls transmission of one piece of manual information to the mobile terminal 10 according to the work menu specified by the selection information. On the other hand, when the identified component is the specific component, the control unit 21 (the viewing information selection unit 24) controls transmission of the screen information to the mobile terminal 10 according to the identified component. Thereafter, when the control unit 21 (the viewing information selection unit 24) receives the selection information indicating that one work menu is selected from the mobile terminal 10, the control unit 21 controls transmission of one piece of manual information to the mobile terminal 10 according to the work menu specified by the selection information and the period of use.

When the storage unit 29 stores the screen information of a layered menu screen, and when the identified component is not the specific component, the control unit 21 (the viewing information selection unit 24) controls transmission of the screen information to the mobile terminal 10 according to the identified component. Thereafter, when the control unit 21 (the viewing information selection unit 24) receives the selection information indicating that one work menu on the bottom layer is selected from the mobile terminal 10, the control unit 21 controls transmission of one piece of manual information to the mobile terminal 10 according to the work menu. On the other hand, when the identified component is the specific component, the control unit 21 (the viewing information selection unit 24) controls transmission of the screen information to the mobile terminal 10 according to the identified component. Thereafter, when the control unit 21 (the viewing information selection unit 24) receives the selection information indicating that one work menu on the bottom layer is selected from the mobile terminal 10, the control unit 21 controls transmission of one piece of manual information to the mobile terminal 10 according to the work menu and the period of use.

That is, when any submenu is selected from the submenu screen of a component α, the mobile terminal 10 transmits selection information indicating that the submenu is selected to the server 20.

When the component α is not a specific component, the control unit 21 (the viewing information selection unit 24) of the server 20 selects one piece of manual information according to the submenu, and performs control so that the manual information is transmitted to the mobile terminal 10. That is, since one piece of manual information corresponding to the submenu is specified when the component α is not the specific component, the control unit 21 (the viewing information selection unit 24) selects that piece of manual information and performs control to respond (transmit) to the mobile terminal 10. On the other hand, when the component α is the specific component, the control unit 21 (the viewing information selection unit 24) of the server 20 selects one piece of manual information according to the submenu and the period of use, and performs control so that that piece of manual information is transmitted to the mobile terminal 10. That is, when the component α is the specific component, the control unit 21 (the viewing information selection unit 24) selects one piece of manual information corresponding to the period of use from a plurality of pieces of manual information corresponding to the submenu and performs control to respond to the mobile terminal 10.

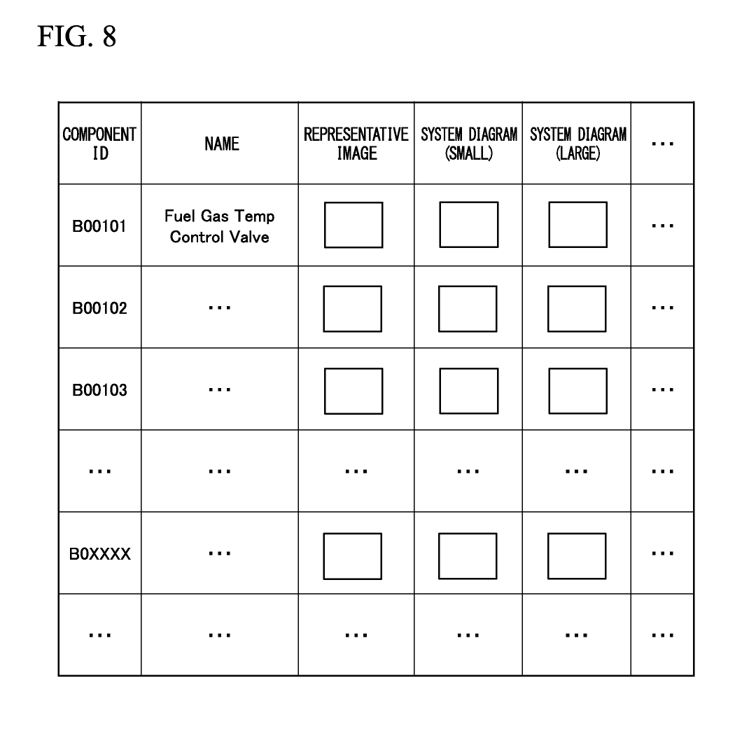

Further, the storage unit 29 may store system diagrams regarding the maintenance target device 90. For example, the storage unit 29 may store a name (a component name), a representative image (a photograph of the component), a system diagram (small), and a system diagram (large) in association with the component ID as shown in FIG. 8. The system diagram (small) is a small system diagram in which a component (a component with a corresponding component ID) and the vicinity of the component are displayed (a system diagram in which a local range is displayed with the component substantially at the center). The system diagram (large) is a large system diagram in which the component and the vicinity of the component are displayed (a system diagram in which a relatively wide range is displayed with the component substantially at the center). There may be a system diagram (small or large) in which the component is not displayed substantially at the center.

When the storage unit 29 stores the system diagrams, the storage unit 29 stores a display position of the component that is displayed in each system diagram. For example, the storage unit 29 may store the component ID and the display position within the system diagram for each system diagram. Specifically, when n components including component 1, component 2, . . . , component n are displayed in a certain system diagram (large), the storage unit 29 may store a display position of the component 1 within the system diagram (large) in association with the component 1, a display position of the component 2 within the system diagram (large) in association with the component 2, . . . , a display position of the component n within the system diagram (large) in association with the component n. Accordingly, it is possible to specify the display position of each of the components displayed in a certain system diagram by referring to the storage unit 29.

Further, when the storage unit 29 stores the system diagrams, the storage unit 29 stores information for specifying a system to which respective components belong (or information specifying components constituting each system). For example, the storage unit 29 may store a system ID for identifying the system and component IDs in association with each other. Accordingly, any component belonging to a certain system (or any component constituting a part of a certain system) can be specified by referring to the storage unit 29.

Although the system diagrams (small and large) are stored for each component in the example shown in FIG. 8, common system diagrams (small and large) may be stored for different components. For example, when the component with the component ID “B00101” and the component with the component ID “B00102” are displayed in a certain system diagram (large) (particularly, when a display position of the component with the component ID “B00101” and a display position of the component with the component ID “B00102” are close to each other in the system diagram), the system diagram (large) stored in association with the component ID “B00101” and the system diagram (large) stored in association with the component ID “B00102” may be the same. Therefore, when all components of the maintenance target device 90 are displayed in a certain system diagram (large), it is sufficient to prepare one system diagram (large) for the maintenance target device 90.

When the storage unit 29 stores the system diagrams regarding the maintenance target device 90, the control unit 21 (the viewing information selection unit 24) controls transmission of the system diagram of the identified component to the mobile terminal 10.

The control unit 21 (the image processing unit 25) may generate a system diagram in which an area according to the alarm information received via the communication unit 28 is highlighted. Further, the control unit 21 (the viewing information selection unit 24) controls transmission of the system diagram in which the area corresponding to the alarm information is highlighted to the mobile terminal 10.

Further, the storage unit 29 may store, for example, a history of transmission and reception to and from the mobile terminal 10 or a history of processing as log information.

The management apparatus 30 includes a control unit 31, an operation reception unit 32, a display unit 33, a communication unit 38, and a storage unit 39, as shown in FIG. 2C. For example, the management apparatus 30 stores alarm information in the maintenance target device 90, and transmits the alarm information to the mobile terminal 10 in response to a request.

FIGS. 9A and 9B to 11 are examples of information displayed on the mobile terminal 10. FIG. 9A shows an example of a menu screen displayed on the mobile terminal 10. Specifically, FIG. 9A is a main menu screen of the component with the component ID “B00101”. That is, “Operation,” “Maintenance,” “Exchange,” and “Trouble shooting” which are the main menus are “Operation (A in FIG. 6A)”, “Maintenance (B in FIG. 6A)”, “Exchange (C in FIG. 6A), and “Trouble shooting (D in FIG. 6A)” corresponding to the component ID “B00101” shown in FIG. 6A.

A name “Fuel Gas Temp Control Valve” of the component shown in FIG. 8 is displayed in a field “Name” of an information area (I in FIG. 9A) in FIG. 9A. Further, a start date of use “YYYY.MM.DD” of the component shown in FIGS. 4A, 4B, and 4C is displayed in a field “Online since” of the information area. Information stored in the server 20 is received and is also displayed in fields “Actuator”, “TAG No”, and “Body”. A representative image of the component shown in FIG. 8 is displayed in a right image area (P in FIG. 9A) of the information area.

FIG. 9B shows an example of a display when an upper area with a phrase “P&I” in the image area (P in FIG. 9A) in the display of FIG. 9A is selected (touched). In the image area, a system diagram (small) of the component shown in FIG. 8 is displayed in place of the representative image. That is, if the area with the phrase “P&I” is selected in the mobile terminal 10, selection information indicating that “P&I” is selected is transmitted to the server 20. The control unit 21 (the viewing information selection unit 24) selects the system diagram (small) of the component and performs control to respond (transmit) to the mobile terminal 10. In the display of FIG. 9B, when an upper area with a phrase “Photo” in the image area (P in FIG. 9B) is selected, the display returns to the display in FIG. 9A. That is, if the area with the phrase “Photo” is selected in the mobile terminal 10, selection information indicating that “Photo” is selected is transmitted to the server 20. The control unit 21 (the viewing information selection unit 24) selects a representative image of the component and performs control to respond (transmit) to the mobile terminal 10.

FIG. 10A shows an example of a menu screen displayed on the mobile terminal 10. Specifically, FIG. 10A shows a submenu screen that is displayed after the main menu “Maintenance” is selected (touched) in the display of FIG. 9A. That is, “Normal inspection”, “Periodic inspection”, and “History information” that are submenus are “Normal inspection (B1 in FIG. 6B)”, “Periodic inspection (B2 in FIG. 6B)”, and “History information (B1 in FIG. 6B)” corresponding to the component ID “B00101” and the main menu “Maintenance” shown in FIG. 6B.

FIG. 10B shows an example of manual information that is displayed on the mobile terminal 10. Specifically, FIG. 10B shows manual information that is displayed after the submenu “Periodic inspection” is selected (touched) in the display of FIG. 10A. That is, the manual information in FIG. 10B is one piece of manual information corresponding to the period of use of the component among a plurality of pieces of manual information corresponding to the component ID “B00101”, the main menu “Maintenance”, and the submenu “Maintenance” shown in FIG. 7 (for example, manual information with a manual number “B001-M2-S2-V1”, manual information with a manual number “B001-M2-S2-V2”, and manual information with a manual number “B001-M2-S2-V3”). The manual information may be information including only text, may be information including a chart as shown in FIG. 10B, or may be information including video or audio.

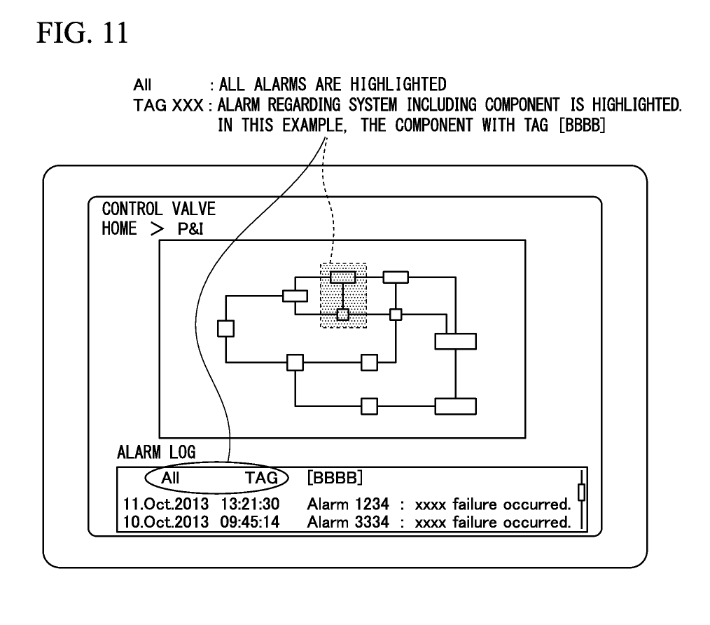

FIG. 11 shows an example of a system diagram that is displayed on the mobile terminal 10. Specifically, FIG. 11 is a display example of a system diagram (large) that is displayed when the system diagram (small) displayed in the image area (P in FIG. 9B) in the display of FIG. 9B is selected (touched). That is, when the system diagram (small) is selected in the mobile terminal 10, selection information indicating that the system diagram (small) is selected is transmitted to the server 20. The control unit 21 (the viewing information selection unit 24) selects the system diagram (large) of the component and performs control to respond (transmit) to the mobile terminal 10 with the system diagram (large). In FIG. 11, the mobile terminal 10 is in a horizontal direction.

In the example of FIG. 11, a system diagram in which an area (a component related to the alarm) according to the alarm information in the maintenance target device 90 is highlighted (a portion indicated by dots in FIG. 11 is highlighted) is displayed. More specifically, an alarm regarding a system including the component (the identified component) among all alarms in the maintenance target device 90 is highlighted. In the display of FIG. 11, when an area of a phrase “All” in an alarm log is selected (touched), all the alarms in the maintenance target device 90 are highlighted. When an area of a phrase “TAG” in the alarm log is selected, an alarm regarding the system including the component (the identified component) is highlighted as shown in FIG. 11. As described above, the control unit 21 (the image processing unit 25) generates a system diagram in which an area according to the alarm information is highlighted, but a variety of generation methods can be considered according to aspects.

### Initial Display

### Example 1

In Example 1 of an initial display, an aspect in which all alarms are highlighted is assumed as the initial display (a display before either the phrase “All” or the phrase “TAG” is selected). When the system diagram (small) is selected (touched) in the mobile terminal 10 and the selection information indicating that the system diagram (small) is selected is received from the mobile terminal 10, the control unit 21 determines for all systems whether there is alarm information. When there is alarm information regarding one of all of the systems, the control unit 21 highlights an area according to the alarm information in the system diagram (large). For example, the control unit 21 refers to the storage unit 29, specifies a display position in the system diagram (large) of the component, and highlights the specified display position. The control unit 21 performs control to respond (transmit) to the mobile terminal 10 with the highlighted system diagram (large).

### Initial Display

### Example 2

In Example 2 of the initial display, an aspect in which an alarm regarding a system including the component (the identified component) is highlighted is assumed as the initial display. When the system diagram (small) is selected (touched) in the mobile terminal 10 and the selection information indicating that the system diagram (small) is selected is received from the mobile terminal 10, the control unit 21 determines whether there is alarm information regarding the system including the component.

When there is alarm information regarding the system including the component, the control unit 21 highlights the area according to the alarm information in the system diagram (large), similarly to Example 1. The control unit 21 performs control to respond (transmit) to the mobile terminal 10 with the highlighted system diagram (large).

### Initial Display

### Example 3

In Example 3 of the initial display, an aspect in which an alarm is not highlighted is assumed as the initial display. When the system diagram (small) is selected (touched) in the mobile terminal 10 and the selection information indicating that the system diagram (small) is selected is received from the mobile terminal 10, the control unit 21 performs control to respond (transmit) to the mobile terminal 10 with the system diagram (large) that is not highlighted, without determining whether there is alarm information. Thereafter, the control unit 21 executes the same process as Example 1 when receiving selection information indicating that the phrase “All” is selected from the mobile terminal 10, and executes the same process as Example 2 when receiving selection information indicating that the phrase “TAG” is selected from the mobile terminal 10.

### Highlighting Display Aspect

### Example 1

In Example 1 of a highlighting display aspect, it is assumed that highlighting information (for example, a highlighting image) is added. For example, the highlighting image is stored for each component in the storage unit 29 in advance. When the control unit 21 highlights a certain component in the system diagram (large), the control unit 21 selects the highlighting image of the component from among a plurality of highlighting images stored in the storage unit 29. The control unit 21 superimposes (pastes) the highlighting image of the component on a display position in the system diagram (large) of the component. The control unit 21 performs control to respond (transmit) to the mobile terminal 10 with the system diagram (large) on which the highlighting image is superimposed. When the control unit 21 does not highlight the system diagram (large), the control unit 21 performs control to respond (transmit) to the mobile terminal 10 with an original system diagram (large) on which the highlighting image is not superimposed.

### Highlighting Display Aspect

### Example 2

In Example 2 of the highlighting display aspect, it is assumed that a system diagram (large) configured of normal information (for example, normal images) and highlighting information (for example, highlighting images) are prepared, and the normal information is replaced with the highlighting information. For example, a normal image and a highlighting image are stored for each component in the storage unit 29 in advance. When the control unit 21 highlights a certain component in the system diagram (large), the control unit 21 selects the highlighting image of the component from among the plurality of highlighting images stored in the storage unit 29 and replaces the normal image corresponding to the component (a component to be highlighted) with the highlighting image of the component for the original system diagram (large) configured of the normal images for all components. The control unit 21 performs control to respond (transmit) to the mobile terminal 10 with the system diagram (large) in which the replacement with the highlighting image is performed on the component. When the control unit 21 does not highlight the system diagram (large), the control unit 21 performs control to respond (transmit) to the mobile terminal 10 with the original system diagram (large).

When there is alarm information in the maintenance target device 90, the mobile terminal 10 transmits the alarm information to the server 20 before the server 20 determines whether there is alarm information (whether highlighting is necessary). For example, the mobile terminal 10 having acquired alarm information from the management apparatus 30 may transmit the alarm information together with the captured image to the server 20 or may transmit the alarm information together with the selection information indicating that the system diagram (small) is selected to the server 20. In a case in which an alarm is not initially displayed (the case of the aspect of Example 3 of the initial display), the mobile terminal 10 may transmit the alarm information together with the selection information indicating that the phrase “All” or the phrase “TAG” is selected to the server 20.

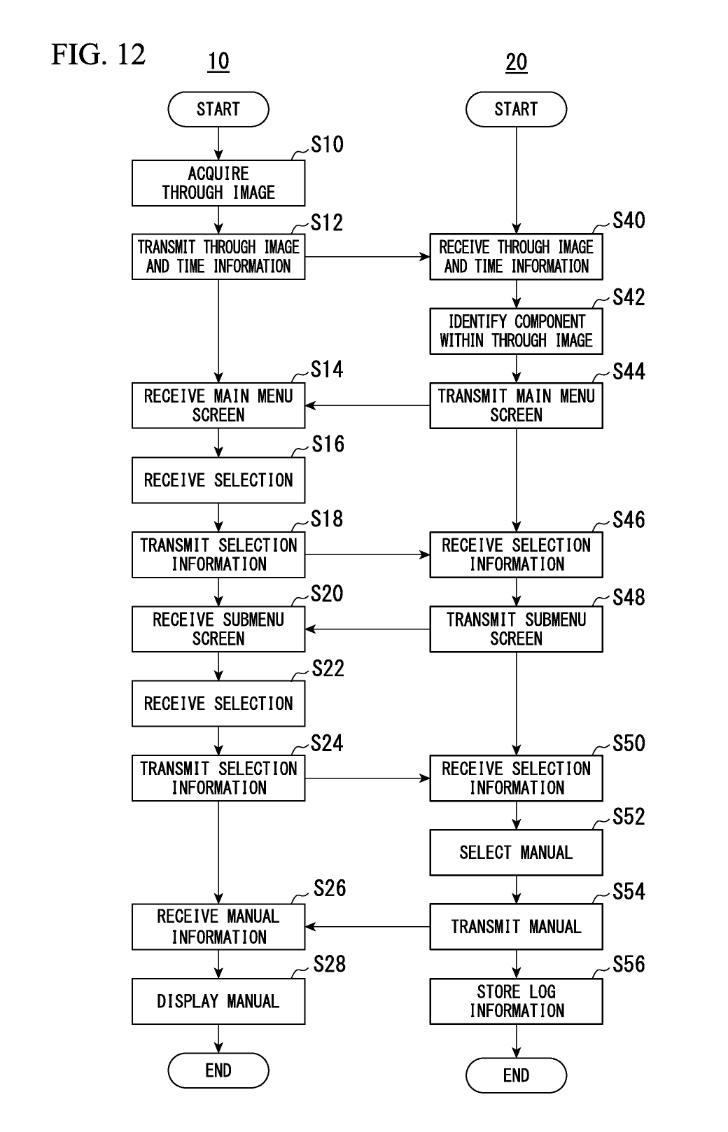

FIGS. 12 to 14A and 14B are flowcharts showing examples of an operation of the mobile terminal 10 and the server 20. The flowchart of FIG. 12 shows an example of an operation in which the mobile terminal 10 transmits a through image to the server 20, and the server 20 identifies a component based on, for example, the through image acquired from the mobile terminal 10 and transmits manual information to the mobile terminal 10. A left flowchart of FIG. 12 shows an operation of the mobile terminal 10, and a right flowchart shows an operation of the server 20.

The flowchart of FIG. 12 shows an example in which the maintenance target device 90 is identified based on position information of the mobile terminal 10. The storage unit 29 is assumed to store the device ID in association with the installation place ID, as shown in FIG. 4B. Further, the mobile terminal 10 is assumed to have already transmitted the position information on the installation position of the maintenance target device 90 to the server 20 before the flowchart of FIG. 12 starts (before the through image is transmitted).

The mobile terminal 10 acquires a through image of one component of the maintenance target device 90 (step S10). For example, an operator (a maintenance person) starts up the imaging unit 14 (the camera) and directs the lens at the component which is a subject, and the mobile terminal 10 acquires the through image of the component. The through image is displayed on the mobile terminal 10 (the display unit 13).

The mobile terminal 10 transmits the through image to the server 20 (step S12). Specifically, when an imaging target is determined to be fixed, the mobile terminal 10 may transmit the through image at that time to the server 20. For example, when an imaging range (the imaging target) of the through image hardly changes for a predetermined time (when the predetermined time elapses in a state in which the degree of motion of the imaging range is smaller than a predetermined reference value), the mobile terminal 10 may transmit the through image at that time to the server 20. Further, the mobile terminal 10 transmits current time information to the server 20 together with the through image (step S12). The mobile terminal 10 may transmit only the through image to the server 20 when transmitting the through image including the photographing time as additional information.

The server 20 receives the through image and the time information from the mobile terminal 10 (step S40). When the mobile terminal 10 transmits the through image including the photographing time as the additional information, the server 20 only receives the through image from the mobile terminal 10.

The server 20 identifies the component within the through image (step S42). Specifically, first, the server 20 specifies an installation place ID based on the position information received from the mobile terminal 10. Subsequently, the server 20 identifies the maintenance target device 90 within the through image based on the installation place ID. Subsequently, the server 20 identifies which one of the components of the maintenance target device 90, which is identified as described above, the component within the through image is based on the degree of similarity of a feature amount of the through image to a feature amount of the comparative image.

The server 20 having identified the component transmits a main menu screen (screen information) corresponding to the component to the mobile terminal 10 (step S44). Specifically, the server 20 extracts phrases of the main menu corresponding to the component from the storage unit 29, and transmits the main menu screen in which the extracted phrases are arranged.

The mobile terminal 10 receives the main menu screen from the server 20 (step S14).

The mobile terminal 10 receives a selection of one main menu on the main menu screen through an operation of the operator (step S16), and transmits selection information indicating that the main menu is selected to the server 20 (step S18).

The server 20 receives the selection information indicating that the main menu is selected from the mobile terminal 10 (step S46). The server 20 transmits a submenu screen (screen information) corresponding to the received main menu to the mobile terminal 10 (step S48). Specifically, the server 20 extracts phrases of the submenu corresponding to the component and the main menu from the storage unit 29, and transmits the submenu screen in which the extracted phrases are arranged.

The mobile terminal 10 receives the submenu screen from the server 20 (step S20). The mobile terminal 10 receives a selection of one submenu on the submenu screen through an operation of the operator (step S22), and transmits selection information indicating that the submenu is selected to the server 20 (step S24).

The server 20 receives the selection information indicating that the submenu is selected from the mobile terminal 10 (step S50). The server 20 selects manual information (indicated as “MANUAL” in FIG. 12) corresponding to the received submenu (step S52). Specifically, when the component (the identified component) identified in step S42 is a specific component (a component for which a plurality of pieces of manual information according to the period of use are stored), the server 20 calculates the period of use of the identified component from mounting date and time information of the identified component and a photographing date and time of the captured image or a reception date and time of the captured image, and selects one piece of manual information according to the period of use from among a plurality of pieces of manual information corresponding to the main menu and the submenu of the identified component. Further, when the component (the identified component) identified in step S42 is not a specific component, the server 20 selects manual information corresponding to the main menu and the submenu of the identified component. In other words, when there are two or more pieces of manual information corresponding to the main menu and the submenu of the identified component according to the period of use, the server 20 selects one piece of manual information according to the period of use of the identified component. When there is only one piece of manual information corresponding to the main menu and the submenu of the identified component, the server 20 selects the one piece of manual information.

The server 20 transmits the manual information selected in step S52 to the mobile terminal 10 (step S54). The server 20 stores processing content after the processes in steps S40 to S54 as log information in the storage unit 29 (step S56). The flowchart on the server 20 side ends.

The mobile terminal 10 receives the manual information from the server 20 (step S26) and displays the manual information (step S28). That is, on the display unit 13 of mobile terminal 10, the manual information of the component within the through image acquired in step S10, which is the manual information corresponding to the menu (the main menu and the submenu) selected (touched) from the menu screen (the main menu screen and the submenu screen) by the operator is displayed. The flowchart on the mobile terminal 10 side ends.

The flowchart of FIG. 12 represents an example of the operation in which the mobile terminal 10 transmits the through image to the server 20, and the server 20 identifies the component based on, for example, the through image acquired from the mobile terminal 10 and transmits the manual information to the mobile terminal 10. The same applies to a case in which the mobile terminal 10 transmits a captured image (including no through image) after pressing of a shutter to the server 20, and the server 20 identifies the component based on, for example, the captured image acquired from the mobile terminal 10 and transmits the manual information to the mobile terminal 10.

Although the flowchart of FIG. 12 is an aspect in which the menu screen of two layers including the main menu and the submenu is included, the same applies to an aspect in which the menu screen consists of one layer or three or more layers or an aspect in which no menu screen is included.

For example, in an aspect of one layer, the process regarding the submenu screen (that is, steps S48 and S50 in the server 20 and steps S20, S22 and S24 in the mobile terminal 10) may be omitted, and the server 20 may select the manual information corresponding to the main menu rather than the submenu in step S52. More specifically, when the component (the identified component) identified in step S42 is the specific component, the server 20 may calculate the period of use of the identified component from mounting date and time information of the identified component and a photographing date and time of the captured image or a reception date and time of the captured image, and select one piece of manual information according to the period of use from among the plurality of pieces of manual information corresponding to the main menu of the identified component. Further, when the component (the identified component) identified in step S42 is not the specific component, the server 20 may select the manual information corresponding to the main menu of the identified component. In the case of the above aspect, the storage unit 29 stores the manual information in association with the component ID and the main menu.

Further, for example, in an aspect in which the menu screen is not included, the process regarding the menu screen (that is, steps S44 to S50 in the server 20 and steps S14 to S24 in the mobile terminal 10) may be omitted, and the server 20 may select the manual information corresponding to the identified component in step S52. More specifically, when the component (the identified component) identified in step S42 is the specific component, the server 20 may calculate the period of use of the identified component from mounting date and time information of the identified component and a photographing date and time of the captured image or a reception date and time of the captured image, and select one piece of manual information according to the period of use from among the plurality of pieces of manual information corresponding to the identified component. Further, when the component (the identified component) identified in step S42 is not the specific component, the server 20 may select the manual information corresponding to the identified component. In the case of the above aspect, the storage unit 29 stores the manual information in association with the component, as shown in FIGS. 3A and 3B.

In the aspect in which the mobile terminal 10 transmits the through image to the server 20, and the server 20 identifies the component based on, for example, the through image acquired from the mobile terminal 10 and transmits the manual information to the mobile terminal 10, the mobile terminal 10 may display the manual information superimposed on the through image. That is, the mobile terminal 10 may display the manual information as augmented reality (AR).

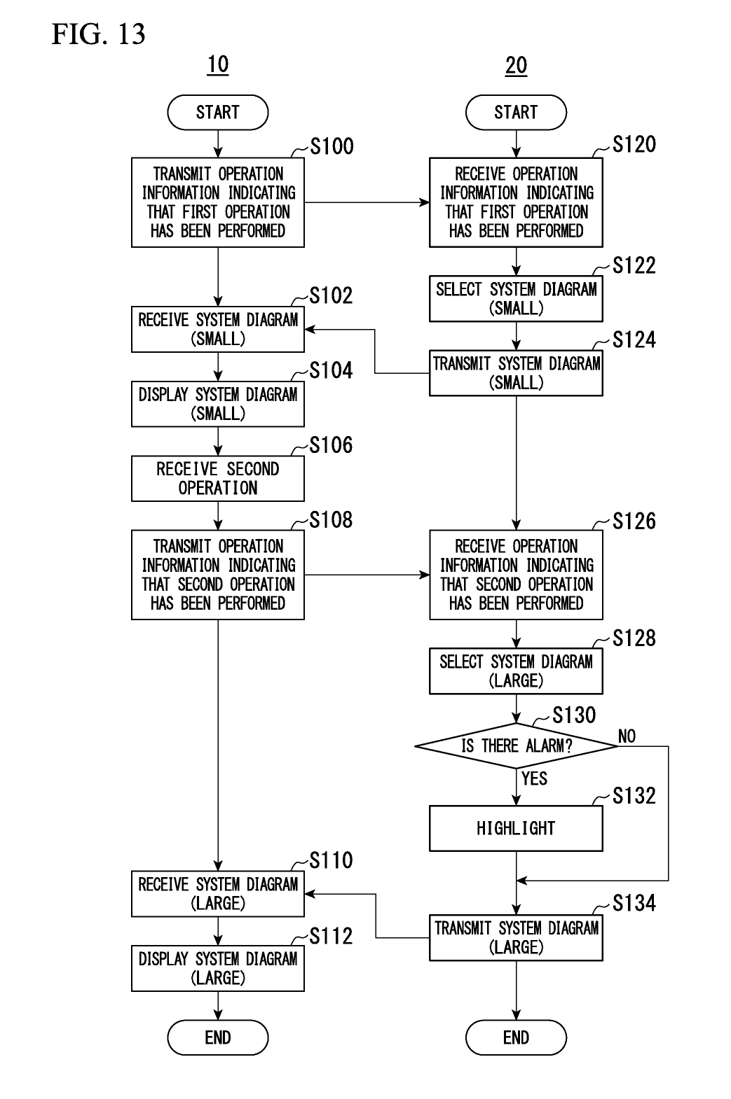

The flowchart of FIG. 13 shows an example of an operation until the system diagram (large) is displayed on the mobile terminal 10. A left flowchart of FIG. 13 shows an operation of the mobile terminal 10, and a right flowchart shows an operation of the server 20. The flowchart of FIG. 13 starts when there is a first operation (for example, touching the area of the phrase “P&I” in FIG. 9A) for displaying the system diagram (small). When the flowchart of FIG. 13 starts, the mobile terminal 10 is assumed to display the main menu screen as shown in FIG. 9A. In an initial display of the system diagram (large), the aspect in which an alarm of a system including the identified component is highlighted (Example 2 described above) is assumed. When there is alarm information in the maintenance target device 90, the mobile terminal 10 is assumed to have transmitted the alarm information to the server 20 before the flowchart of FIG. 13 starts.

The mobile terminal 10 transmits operation information indicating that there is the first operation (for example, touching the area of the phrase “P&I” in FIG. 9A) (selection information indicating that “P&I” is selected) to the server 20 (step S100).

The server 20 receives the operation information indicating that there is the first operation from the mobile terminal 10 (step S120). The server 20 having received the operation information indicating that there is the first operation selects the system diagram (small) corresponding to the identified component (the component in FIG. 9A) (step S122), and transmits the system diagram (small) to the mobile terminal 10 (step S124).

The mobile terminal 10 receives the system diagram (small) from the server 20 (step S102), and displays the system diagram (small) on the display unit 13 (step S104). That is, the system diagram (small) is displayed on the display unit 13 of the mobile terminal 10, as shown in FIG. 9B rather than as shown in FIG. 9A. The mobile terminal 10 receives a second operation for displaying the system diagram (large) (for example, touching the area of the system diagram (small) displayed in step S104) (step S106). The mobile terminal 10 transmits operation information indicating that there is the second operation (selection information indicating that the system diagram (small) is selected) to the server 20 (step S108).

The server 20 receives the operation information indicating that there is the second operation from the mobile terminal 10 (step S126). The server 20 having received the operation information indicating that there is the second operation selects the system diagram (large) corresponding to the identified component (the component in FIG. 9A) (step S128). The server 20 determines whether there is an alarm (alarm information) in the system including the identified component (step S130). When the server 20 determines that there is an alarm in the system including the identified component (step S130: Yes), the server 20 highlights an area corresponding to the alarm in the system diagram (large) selected in step S128 (step S132). On the other hand, when the server 20 determines that there is no alarm in the system including the identified component (step S130: No), the server 20 does not perform highlighting. Subsequent to step S132 or step S130 (No), the server 20 transmits the system diagram (large) to the mobile terminal 10 (step S134). That is, a highlighted system diagram (large) is transmitted to the mobile terminal 10 when there is the alarm, and a non-highlighted system diagram (large) is transmitted to the mobile terminal 10 when there is no alarm. The flowchart on the server 20 side ends.

The mobile terminal 10 receives the system diagram (large) from the server 20 (step S110), and displays the system diagram (large) on the display unit 13 (step S112). The flowchart on the mobile terminal 10 side ends.

In the flowchart of FIG. 13, although the aspect in which the system diagram (small) is transmitted from the server 20 to the mobile terminal 10 by the first operation, and the system diagram (large) is transmitted from the server 20 to the mobile terminal 10 by the second operation has been described, the system diagram (small) and the system diagram (large) may be transmitted from the server 20 to the mobile terminal 10 by the first operation. In the aspect in which the system diagram (small) and the system diagram (large) are transmitted from the server 20 to the mobile terminal 10 by the first operation, the mobile terminal 10 may display the system diagram (small) and the system diagram (large) together when receiving the system diagram (small) and the system diagram (large) after the first operation, or may display only the system diagram (small) when receiving the system diagram (small) and the system diagram (large) after the first operation and may first display the system diagram (large) after there is the second operation.

Further, in the flowchart of FIG. 13, although the aspect in which the system diagram (small) is displayed by the first operation and the system diagram (large) is displayed by the second operation has been described, the system diagram (large) may be displayed first by the first operation without the system diagram (small) being displayed.

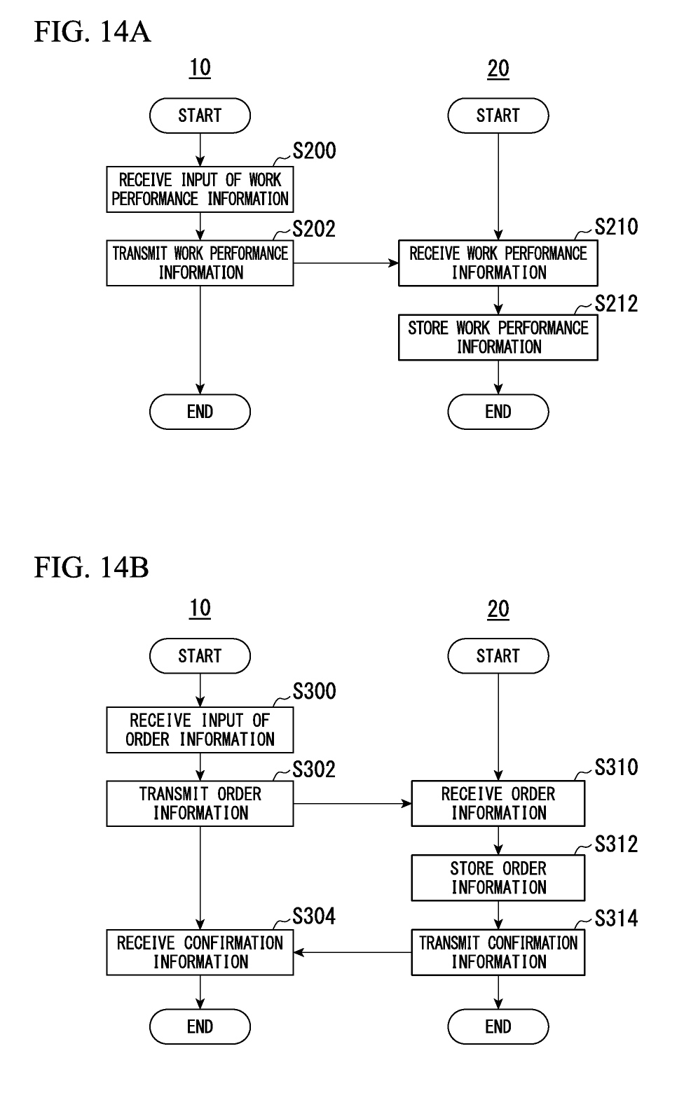

A flowchart of FIG. 14A shows an example of an operation in which the server 20 acquires work performance information from the mobile terminal 10. A left flowchart of FIG. 14A shows an operation of the mobile terminal 10, and a right flowchart shows an operation of the server 20.

The mobile terminal 10 receives an input of work performance information (step S200). That is, an operator, for example, performs maintenance work by referring to manual information displayed on the mobile terminal 10, and inputs the work performance information to the mobile terminal 10 after work completion. The server 20 may transmit a work performance input screen having an input field for the work performance information when transmitting the manual information, and the mobile terminal 10 may receive the input of the work performance information through the work performance input screen. The mobile terminal 10 transmits the work performance information to the server 20 (step S202). When the mobile terminal 10 calculates a working time (to be described below), the mobile terminal 10 transmits the working time to the server 20 together with the work performance information. The flowchart on the mobile terminal 10 side ends.

The server 20 receives the work performance information from the mobile terminal 10 (step S210). The server 20 stores the work performance information in the storage unit 29. The server 20 may store the work performance information in the storage unit 29 together with the working time. The working time may be calculated from, for example, a difference between a transmission time of the manual information and a reception time of the work performance information at the server 20, or may be calculated from, for example, a difference between a reception time of the manual information and a transmission time of the work performance information at the mobile terminal 10. The flowchart on the mobile terminal 10 side ends.

A flowchart of FIG. 14B shows an example of an operation in which the server 20 acquires order information from the mobile terminal 10. A left flowchart of FIG. 14B shows an operation of the mobile terminal 10, and a right flowchart shows an operation of the server 20. A destination to which the mobile terminal 10 transmits the order information may be the server 20 or may be another server different from the server 20, but it is assumed in this flowchart that the mobile terminal 10 transmits the order information to the server 20.

The mobile terminal 10 receives an input of order information for a component (step S300). That is, an operator inputs, for example, the order information for a component to the mobile terminal 10 when the component is necessary in maintenance work. The server 20 may transmit an order screen having an input field for the order information when transmitting manual information, and the mobile terminal 10 may receive an input of the order information through the order screen. The mobile terminal 10 transmits the order information to the server 20 (step S302).

The server 20 receives the order information from the mobile terminal 10 (step S310). The server 20 stores the order information in the storage unit 29 (step S312). The server 20 transmits confirmation information (order reception information) to the mobile terminal 10 (step S314). The flowchart on the server 20 side ends.

The mobile terminal 10 receives the confirmation information from the server 20 (step S304), and displays the confirmation information on the display unit 13. The flowchart on the mobile terminal 10 side ends.

Although the mobile terminal 10 transmits the order information to the server 20 in the flowchart of FIG. 14B, the server 20 may transmit link information which enables the mobile terminal 10 to acquire the order screen from another server together with the manual information when the mobile terminal 10 transmits the order information to the other server different from the server 20.

As described above, according to the above embodiment, it is possible to display an appropriate instruction manual according to an elapsed time for a component for which a handling method is changed over time (a specific component).

Although the management apparatus 30 stores the alarm information in the maintenance target device 90 and the mobile terminal 10 acquires the alarm information from the management apparatus 30 in the above embodiment, the mobile terminal 10 may directly acquire the alarm information from the maintenance target device 90. When an aspect in which the mobile terminal 10 directly acquires the alarm information from the maintenance target device 90 is adopted, the management apparatus 30 may be omitted. That is, the device maintenance system may be composed of the mobile terminal 10 and the server 20.

Further, although the system diagram is highlighted according to the alarm information in the above embodiment, an aspect in which highlighting is not performed on the system diagram may be adopted. When the aspect in which highlighting is not performed on the system diagram is adopted, the management apparatus 30 may be omitted. That is, the device maintenance system may be composed of the mobile terminal 10 and the server 20. Further, when the aspect in which highlighting is not performed on the system diagram is adopted, the server 20 (the control unit 21) does not have to have the function of executing the process regarding highlighting (the image processing unit 25). Further, the same applies in a case in which the system diagram itself is not displayed on the mobile terminal 10 since the alarm information is not necessary.

Further, although one server 20 has been described in the above embodiment as shown in FIG. 1, the server 20 may be configured as two or more servers (for example, a server 20A, a server 20B, and a server 20C). That is, for example, the device identification unit 22, the component identification unit 23, the viewing information selection unit 24, the image processing unit 25, and the storage unit 29 may be dispersed in the server 20A, the server 20B, and the server 20C.

The above-described various processes of the entire device maintenance system, the mobile terminal 10, the server 20, or the management apparatus 30 may be performed by recording a program for executing each process of the entire device maintenance system, the mobile terminal 10, the server 20, or the management apparatus 30 on a computer-readable recording medium, loading the program recorded on the recording medium to a computer system and executing the program. Further, the “computer system” stated herein may include an OS or hardware such as a peripheral device. Further, the “computer system” also includes a homepage providing environment (or a display environment) if the WWW system is being used. Further, the “computer-readable recording medium” includes a flexible disk, a magneto-optical disc, a ROM, a writable nonvolatile memory such as a flash memory, or a portable medium such as a CD-ROM, or a storage device such as a hard disk built in a computer system.

Further, the “computer-readable recording medium” also includes a recording medium that holds a program for a certain time, such as a volatile memory (for example, a dynamic random access memory (DRAM)) inside a computer system including a server and a client when a program is transmitted over a network such as the Internet or a communication line such as a telephone line. Further, the program may be transmitted from a computer system in which the program is stored in a storage device or the like to other computers via a transfer medium or by transfer waves in the transfer medium. Here, the “transfer medium” for transferring the program refers to a medium having a function of transferring information, such as a network (a communication network) such as the Internet or a communication line such as a telephone line. Further, the program may be a program for realizing some of the above-described functions. Further, the program may be a program capable of realizing the above-described functions in combination with a program previously stored in the computer system, that is, a so-called differential file (a differential program).

While the embodiments of the present invention have been described above with reference to the drawings, the specific configuration is not limited to the embodiments but includes a design or the like in a range not departing from of the gist of the present invention.

### INDUSTRIAL APPLICABILITY

With the device maintenance server and the device maintenance system described above, it is possible to display an appropriate instruction manual according to an elapsed time for a component for which a handling method is changed over time.

### REFERENCE SIGNS LIST

10 Mobile terminal
11 Control unit
12 Operation reception unit
13 Display unit
14 Imaging unit
15 Position acquisition unit
16 Clock unit
18 Communication unit (terminal-side communication unit)
19 Storage unit
20 Server (device maintenance server)
21 Control unit
22 Device identification unit
23 Component identification unit
24 Viewing information selection unit
25 Image processing unit
28 Communication unit (server-side communication unit)
29 Storage unit
30 Management apparatus
31 Control unit
32 Operation reception unit
33 Display unit
38 Communication unit
39 Storage unit
90 Maintenance target device (gas turbine)

1. A device maintenance server that transmits viewing information to be viewed in maintenance work to a mobile terminal carried for the maintenance work of a maintenance target device, the device maintenance server comprising:
a storage unit configured to store manual information on each component configuring the maintenance target device as the viewing information;
a communication unit configured to communicate with the mobile terminal; and
a control unit configured to control transmission of the manual information to the mobile terminal according to information received from the mobile terminal via the communication unit,
wherein the storage unit is configured to store a plurality of pieces of manual information according to a period of use that is a period after mounting on the maintenance target device for each of at least a part of specific components among the components configuring the maintenance target device, and store mounting date and time information of the mounting on the maintenance target device for each of the specific components, and
wherein the control unit is configured to identify the component captured in a captured image received from the mobile terminal, calculate the period of use of the identified component from the mounting date and time information of the identified component and a photographing date and time of the captured image or a reception date and time of the captured image when the identified component is the specific component, and control transmission of one piece of manual information according to the period of use among the plurality of pieces of manual information of the identified component.

2. The device maintenance server according to claim 1,
wherein the storage unit is configured to store manual information that does not depend on the period of use for each component that is not the specific component, and
wherein the control unit is configure to control transmission of the manual information according to the identified component when the identified component is not the specific component.

3. The device maintenance server according to claim 1,
wherein the storage unit is configured to store a comparative image obtained by previously imaging each of the components or feature amount information on a feature amount of the comparative image, and
wherein the control unit is configured to identify the component captured in the captured image according to a degree of similarity of a feature amount of the captured image to the feature amount of the comparative image.

4. The device maintenance server according to claim 1,
wherein the storage unit is configured to store screen information of a menu screen that causes a work menu according to the component to be selected, stores a plurality of pieces of manual information according to the work menu for the component that is not the specific component, and store a plurality of pieces of manual information according to the work menu and the period of use for the specific component, and
wherein the control unit:
is configured to control transmission of the screen information to the mobile terminal according to the identified component when the identified component is not the specific component, and then control transmission of one piece of manual information to the mobile terminal according to the work menu specified by selection information when receiving the selection information indicating that any work menu is selected from the mobile terminal; and
is configured to control the transmission of the screen information according to the identified component to the mobile terminal when the identified component is the specific component, and then control the transmission of one piece of manual information according to the work menu specified by the selection information and the period of use to the mobile terminal when receiving the selection information indicating that any work menu is selected from the mobile terminal.

5. The device maintenance server according to claim 4,
wherein the storage unit is configured to store screen information of the layered menu screen, and store the manual information in association with the work menu on a bottom layer, and
wherein the control unit:
is configured to control the transmission of the screen information according to the identified component to the mobile terminal when the identified component is not the specific component, and then control the transmission of one piece of manual information according to the work menu to the mobile terminal when receiving selection information indicating that any work menu on the bottom layer is selected from the mobile terminal; and
is configured to control the transmission of the screen information according to the identified component to the mobile terminal when the identified component is the specific component, and then control the transmission of one piece of manual information according to the work menu and the period of use to the mobile terminal when receiving the selection information indicating that any work menu on the bottom layer is selected from the mobile terminal.

6. The device maintenance server according to claim 1,
wherein the storage unit is configured to store system diagrams regarding the maintenance target device, and
wherein the control unit is configured to control transmission of the system diagram of the identified component to the mobile terminal.

7. The device maintenance server according to claim 6,
wherein the communication unit is configured to receive alarm information in the maintenance target device, and
wherein the control unit is configured to generate a system diagram in which an area is highlighted according to the alarm information and control transmission of the system diagram to the mobile terminal.

8. The device maintenance server according to claim 1,
wherein the communication unit is configured to receive order information of the component or work performance information after the maintenance work.

9. A device maintenance system comprising a device maintenance server configured to store viewing information to be viewed in maintenance work of a maintenance target device, and a mobile terminal configured to communicate with the device maintenance server,
wherein the mobile terminal includes:
a display unit configured to display the viewing information;
an operation reception unit configured to receive an operation of an operator;
an imaging unit configured to image the maintenance target device; and
a terminal-side communication unit configured to communicate with the device maintenance server,
wherein the device maintenance server includes:
a storage unit configured to store manual information on each component configuring the maintenance target device as the viewing information;
a server-side communication unit configured to communicate with the mobile terminal; and
a control unit configured to control transmission of the manual information to the mobile terminal according to information received from the mobile terminal via the server-side communication unit,
wherein the storage unit is configured to store a plurality of pieces of manual information according to a period of use that is a period after mounting on the maintenance target device for each of at least a part of the components configuring the maintenance target device, and store mounting date and time information of mounting on the maintenance target device for each specific component that is a component for which the plurality of pieces of manual information according to the period of use are stored,
wherein the terminal-side communication unit is configured to transmit a captured image of the component captured using the imaging unit to the device maintenance server, and
wherein the control unit is configured to identify the component captured in the captured image received from the mobile terminal, calculate the period of use of the identified component from the mounting date and time information of the identified component and a photographing date and time of the captured image or a reception date and time of the captured image when the identified component is the specific component, and control transmission of one piece of manual information according to the period of use among the plurality of pieces of manual information of the identified component.
